(19) United States
(12) Patent Application Publication
(10) Pub. No.: US 2011/0284509 A1
(43) Pub. Date: Nov. 24, 2011

(54) Deflection Mirror and Device for Laser Inscribing with the Deflection Mirror Unit

(75) Inventor: Rudiger Kreuter, Darmstadt (DE)

(73) Assignee: NanoSec Gesellschaft fur Nanotechnologie in der Sicherheitstechnik mbH, Darmstadt (DE)

(21) Appl. No.: 13/108,580

(22) Filed: May 16, 2011

(30) Foreign Application Priority Data
May 20, 2010 (EP) 10163411.1

(51) Int. Cl. B23K 26/06; G02B 26/08

(52) U.S. Cl. 219/121.67; 359/225.1; 359/221.2

(57) ABSTRACT

In order to keep the entire unit compact e.g. in a laser inscribing unit in spite of the laser beam impacting the card to be inscribed in an orthogonal manner a relatively large amount of beam deflections is necessary partially through mirrors that are fixated relative to one another. In order to minimize the assembly and adjustment complexity plural beam deflections are caused subsequent to one another through a prism element where the beam deflections are implemented through particular reflection surfaces. The prism element is received in a prism support which is configured to be pivoted and rotated in its entirety for assembly and adjustment purposes.

### CROSS REFERENCE TO RELATED APPLICATION

This application takes priority from and claims the benefit under 35 U.S.C. §119 of European Patent Application Ser. No. 10163411.1 filed on May 20, 2010 the contents of which are hereby incorporated by reference.

### BACKGROUND OF THE INVENTION

1. Field of the Invention

The instant invention relates to a deflection mirror unit for three optical beam deflections of a laser beam and it relates to laser inscribing of card type substrates, e.g. ID cards, credit cards, check cards and similar flat planar objects with two main surfaces extending parallel to one another, wherein at least one of them shall be inscribed using the deflection mirror.

2. Description of the Related Prior Art

Inscribing in particular cards made from plastic material with a laser is well known in the art since the energy of the laser beam causes a carbonization and thus blackening of the carbon compounds of the substrate and thus a permanent coloration deep into the base material.

The coloration can also be provided through absorption of the laser light by the substrate or by portions of the substrate like e.g. embedded colorants etc. or bursting of encapsulated pigments.

Depending on the energy of the laser light and the positioning of the focal point the inscribing effect can be provided at the surface or also in the depth of the substrate, wherein the latter is typically only used when a cover layer is provided above the impacted layer, wherein the cover layer is at least transparent for the laser radiation so that the color change caused by the laser which can be an inscription as well as an image is recognizable with a bare eye.

Since cards of this type typically have to be inscribed in large numbers and color changes have to be generated on the card through the laser beam pixel by pixel the laser aperture, in particular the laser source is typically arranged in prior art inscribing devices orthogonal to the main plane of the card to be inscribed and the beam is deflected through movable deflection mirrors in an X-direction and in a Y-direction of the main plane of the card so that the desired inscription is provided on a non-moving card.

Since the respective deflection mirrors or polygon mirrors only have to be rotated by very small angles and thus movement paths, the further remote they are from the card to be inscribed this movement of the deflection mirrors and thus inscribing the card can be provided very quickly overall.

This however causes relatively large overall dimensions of the laser inscribing device.

When the card shall furthermore be inscribed on both sides through a laser the card either has to be rotated for inscribing the backside and inserted into the device again, or the device which is already configured rather tall is configured in a redundant double arrangement for inscribing the top side and the bottom side and thus is doubled in size again.

However, when a laser inscribing device shall be built which has small dimensions in spite of simple and cost effective configuration while still providing quick inscribing on the one hand side the laser beam is only moved back and forth in the main plane of the card which extends in the X-direction and in the Y-direction, wherein the back and forth movement is only provided in one direction, e.g. in the Y-direction in an oscillating manner through a fan mirror, wherein the other direction, e.g. the X-direction is preferably implemented through moving the card in a card slide or through beam deflection through an optical slide.

Thus, when the laser source emits the laser beam in one direction parallel and in particular in the main plane of the card the laser beam can be conducted through a switchable selective mirror optionally into a portion above or below the main plane of the card and thus the card can be inscribed optionally once from the top and another time from the bottom.

Independently there from at least one non-moving deflection mirror is provided when emitting the laser beam in one direction parallel to the main plane of the card when the laser beam is arranged in the card plane and in movement direction of the card slide even three non-moving deflection mirrors are required on each side of the main plane of the card slide wherein an inscription shall be provided from the main plane of the card slide.

Since a correct adjustment of these e.g. three non-moving deflection mirrors is essential for a correctly positioned inscribing of the cards through a laser beam the deflection mirrors have to be adjusted very precisely when the inscription device is built and also when environmental conditions change e.g. when a temperature changes and the deflection mirrors also have to be readjusted.

This adjustment complexity is very high when there are three non-moving deflection mirrors above the main plane and three non-moving deflection mirrors below the main plane and correct adjustment requires a substantial amount of time and skill.

### SUMMARY OF THE INVENTION

The instant invention, as illustrated herein, is clearly not anticipated, rendered obvious or even present in any of the prior art mechanisms, either alone or in any combination thereof.

Thus it is the object of the invention to provide a deflection mirror unit and a laser inscribing device including the deflection mirror unit which are producible in a simple and cost effective manner and which simplify in particular the adjustment of the fixated deflection mirrors.

It has become apparent that the exit angle of the laser beam is partially independent from a tilting of the prism element about the X- Y- or Z- axis and only is a function of the entry angle into the prism element through an arrangement of the three deflection planes for the triple beam deflection at an angle relative to one another, the so-called pivot angle which is in particular 90°.

Also the direction of the surface orthogonal of the beam fan is independent from a rotation of the prism element.

Thus, it is proposed according to the invention to position the three reflection surfaces for the three deflections so that they are fixated and not changeable relative to one another, e.g. at a single prism element as total reflection surfaces.

Thus only the entire prism element can still be adjusted in its position relative to its environment, e.g. a receiving housing; however this is sufficient due to the partial compensation of angular errors within the three deflection elements.

On the other hand side this also significantly reduces adjustment complexity.

A first adjustment of the prism is necessary when building the unit to hit the reflection surfaces in their centers with a non-deflected centric laser beam in order to thus assure that the entire beam fan is reflected at all three reflection surfaces without losses and no lateral cut off of a beam fan occurs in one of the deflections.

Furthermore an undesirable self-acting adjustment through temperature changes, concussions and similar environmental impacts is reduced.

In order to support and adjust the prism element in a simple manner it is received in a prism support which is adjustable relative to the housing.

Thus, the prism element is pivoted about one of the two directions which define its main plane, in particular the X-direction and the Y-direction.

Thus, a plane is defined as the main plane wherein the plane extends through all three reflection surfaces of the prism element.

This is as a matter of principle not a single plane but a limited number of planes, since each of the reflection surfaces have a limited spatial extension. However, it is sufficient when this condition is maintained for one of the planes of this limited number of planes.

Preferably the prism support and thus the prism element are only adjusted through pivoting about the two intersecting special directions and no other adjustment is performed.

In case an additional adjustment is performed this is a rotation about a third spatial axis intersecting the two other spatial directions and in particular arranged perpendicular thereto, in particular the Z-axis.

The adjustment movements are implemented in the simplest possible and still reliable and precise manner by providing the pivoting e.g. through pivot screws in that the prism support is made from two components moveable relative to one another, namely the prism component which receives the prism element and the fixating component which is fixated at the housing.

The pivot elements like e.g. the pivot screws are arranged between both components and thus pivot the prism component relative to the fixated fixating component.

Additionally springs can be arranged there between which always keep the two components under a desired preload relative to one another so that only one force has to be imparted in one direction through the screws, thus against the spring force and the reverse force is applied through the spring force.

The rotation is facilitated in that the fixation component is a disc or a ring with a circular outer circumference, in particular with a circumferential shoulder and contacts the receiving housing with an outer circumference thus at least over a portion of the circumference thus over circumferential segments.

Between a circular fixation component of this type and a receiving housing which geometrically facilitates a rotation of the circular fixation component rotation elements like e.g. rotation screws can be arranged through whose rotation the circular fixation component can be slightly rotated in the receiving housing. Thus e.g. the rotation screws can be disposed in the plane of the ring or of the disc of the fixation component, can be supported at the housing and can press tangentially against a protruding stop of the fixation component and can thus cause a rotation.

With respect to the adjustment elements and rotation elements care has to be taken that they are configured self-hemming since this facilitates omitting additional clamping elements.

For simple mounting of the prism support in the surrounding housing the housing is preferably configured into pieces and engages with each of its housing components over a maximum of 180° of circumference for a circular fixation component.

Thus the circular fixation component can be inserted in one housing component in a direction of its radial plane and subsequently the second housing component can be bolted to the first housing component which fixates the prism support in the housing since in particular the portion with larger diameter of the prism support caused by the shoulder is then disposed on the one side and the other prism component oriented away from the shoulder is disposed on the other side of the plane of an annular support of the housing.

Therefore the fixation component, in particular the circular fixation component is offset to the main plane of the prism element and thus arranged above or below the prism element and thus at a distance that is as small as possible which yields optimum small lever arms between the fixation component and the prism element e.g. compared to an arrangement where the fixation component is arranged in the plane of the prism element and laterally offset thereto, since the prism element is typically a flat prism element whose extension in its main plane is significantly greater than transversal thereto.

In a preferred embodiment the corners which are typically not used for beam control are respectively cut off so that a rectangle, a pentagon or a hexagon can be achieved.

In top view of the main plane the prism element is a rectangular triangle whose hypotenuse is arranged in particular at an angle of 45° respectively to its two catheti. However the prism element does not necessarily form an equilateral triangle since one corner of the triangle which is formed by the hypotenuse and a cathetus is cut off so that it is a shape that is a rough triangle but in particular a rectangle, in particular with two sides that are parallel to one another.

The prism element is arranged in the prism support so that a hypotenuse extends below the circular fixation component and in particular exactly below its center.

In order for the rotation of the fixation component through the rotation elements to be possible also when the threaded connections of the fixation component at the housing are already applied, but not tightened the pass through openings through which the fixation bolts extend through which the fixation component is bolted to the housing have a substantially larger diameter than the diameter of the fixation bolts.

The prism element has to be received in the prism support with as little clearance as possible so that the adjustment movements of the prism support are directly transferred to the prism element 1:1.

For this purpose the prism element is either glued into the prism support or preferably supported therein through form locking, in particular only supported therein through form locking.

Then, however the prism element is supported in the prism support at least in a direction transversal to the main plane, preferably in all three directions in space through a spring force permanently against form locking stops of the prism support, e.g. through elastic spring tongues which are elements of the prism support.

This is facilitated e.g. in that the prism support is made from plastic material which is also the preferred material for the housing.

A prism support of this type can substantially enclose the prism element on all sides besides an insertion opening through which the prism element can be inserted into the prism support and besides pass through openings for the laser beam at the locations where the laser beam enters the prism element and exits the prism element.

Since the laser beam is a laser beam that moves in a fan portion the pass through openings are slot shaped or have elongated rectangular shapes.

The rest of the prism element is covered by the prism support which prevents undesirable entry and exit of laser light and also of external light. Therefore the prism support is made from non-transparent material and in particular from non-reflective material on the side oriented towards the prism element.

A deflection mirror unit of this type can be used for all situations where a light beam that is deflected in a fan shape like e.g. a laser beam can go through three beam deflections in relatively short sequence, whose deflection planes are arranged at an angle to one another and where in particular the exit direction is parallel but opposite to the entry direction and in particular the deflection planes are oriented perpendicular to one another. The latter would also be possible with only two beam deflections however with a lower error compensating effect.

A preferred embodiment of the deflection mirror unit is an application in a laser inscribing device, in particular when the card to be inscribed shall be processed with a laser in the same fixture in the device or in the card slide of the device sequentially from the top and also from the bottom, thus on both sides of the card.

The housing of the deflection mirror unit which receives the prism support of the deflection mirror unit can also be an element of the base frame of the laser inscribing device in that the three non-moving deflection mirrors are replaced by the deflection mirror unit, thus in particular its prism element.

When only the housing component that surrounds the fixation component is provided in two pieces certainly only one of them can be a component of the base frame of the laser inscribing device.

When the cards in the laser inscribing device are laser processed in one clamping step from the top and also from the bottom one of two preferably mirror symmetrical or identical deflection mirror units is provided on both sides of the card-main center plane and mounted mirror symmetrical thereto.

The combination of the three beam deflections in a prism element also has the effect that the prism element can be kept with overall small dimensions which also helps to configure the laser inscribing device as small and compact as possible.

A very compact configuration is also provided in that the deflection of the laser beam relative to the card surface is only implemented in one direction, e.g. the Y-direction by the laser beam through respective beam control, thus in particular through deflection mirrors, e.g. a galvanometer mirror or a rotating polygonal mirror and additional deflection mirrors, while the movement in the other direction, the X-direction is implemented through the movement of the card in that it is fixated in a card slide that is moveable in this direction. Instead of a movement of the substrate (card) also a movement at least of the last deflection mirror along the substrate can be provided as a so-called “optical slide.”

This is caused by the fact that due to the deflection of the laser beam in only one direction the laser beam instead of having to be spread into a three dimensional cone only has to be spread into a two dimensional fan which has the consequence that the respective deflection mirrors only have to have a significant extension in the one direction, namely the width of the fan and can be configured very narrow in the other spatial direction.

The fact that the card slide (optical slide in case of the movement of the last mirror) cannot be accelerated and thus moved as quickly as a light deflection mirror due to its much larger mass only superficially at first glance leads to a strong increase of the inscribing time. Thus the card slide or the optical slide does not have to be moved for inscribing each particular pixel but in an X-position of the card slide or optical slide plural, preferably all Y-positions are inscribed, so that the card slide only has to be accelerated according to the number of X-positions in which it is being moved.

Since the moveable galvanometer mirror or polygon mirror, subsequently designated as fan mirror which deflects the laser beam in a fan shape moves in increments according to the Y-positions of the desired pixels to be inscribed on the card a control is certainly required which controls the laser according to the angular position of the fan mirror and additionally also according to the current X-position of the card slide or the optical slide, thus causes a laser shot at the desired X-Y-position and thus also controls the power of the laser.

An additional reduction of the size of the device is achieved according to the invention when the card is to be inscribed on both sides.

In this case the card is only fixated along the edges which do not have to be inscribed, in the support of the card slide, however the card does not contact the card slide with its entire bottom side or is not covered at its bottom side by the card slide.

Thus in one receiving step in the card slide subsequently the inscribing of the two sides of the card can be provided from the top and also from the bottom.

For this purpose a selection mirror is provided for the laser beam wherein the selection mirror is pivotable back and forth in particular between two positions wherein the selection mirror optionally conducts the beam to the top side or to the bottom side of the card received in the card holder.

The selection mirror is preferably arranged laterally adjacent to the card slide or the optical slide and its movement path and in the beam path still before the at least one non-moving deflection mirror, but behind the fan mirror wherein for this purpose certainly the at least one deflection slide has to be provided on each of the two sides of the main plane of the card analogously.

Preferably the selection mirror is pivoted exactly by 90° between the two positions and the optical axis of the laser beam aperture extends parallel to the optical main plane of the card slide, in particular on the center main plane and thus adjacent to the movement path of the card slide, so that the selection mirror rotates about a pivot axis extending in Y-direction adjacent to the card slide.

Since a portion of the beam path is arranged adjacent to the movement path of the card slide or of the optical slide this already does not require any installation height perpendicular to the card slide or to the plane of the card slide.

The device furthermore becomes particularly simple in its configuration in that the laser beam behind the selection mirror through the fixated reflection surfaces on each side of the main plane is not deflected through the theoretically possible two beam deflections but through three deflections wherein each of them has a 90 degree deflection angle.

This has the effect on the one hand side that all three deflections on each of the sides have the same entry and exit angle at the respective reflection surface for two sided inscribing, thus because of the same reflection conditions, e.g. when using mirrors instead of a prism element they can have the same dielectric coding which would not be the case when using only two deflections on each side.

Thus the reflection surfaces of the deflections are mounted and aligned so that the focal point of the laser beam is always arranged on the surface of the card disposed in the card slide, irrespective of the position of the moving mirrors, thus the selection mirrors and fan mirrors which are the only mirrors in the device that are being moved during the inscribing process.

When a focal point is required below the surface of the card, thus in a lower layer of the card the three reflection surfaces that are not being moved during the inscribing process can be readjusted with respect to their distances to the card. An adjustment movement either of the supports for the card slide in its elevation position, thus transversal to the X-Y-direction or a replaceable receiver in the card slide so that different receivers with different elevation positions of the card in the card slide are facilitated can be performed when only a one-sided inscribing of the card is to be provided.

Furthermore the device can be improved so that a surface is inscribed by the laser with an optical lens structure according to the CLI—or MLI method.

Since the laser beam must not impact the surface of the card in an orthogonal manner as provided for the basic version of the device according to the invention a slanted prism can be automatically inserted into the beam path of the laser between the last deflection mirror and the card surface for deflecting and thus slanted impact of the laser beam on the card surface. The movement of the impact point of the laser beam on the card surface caused by the beam deflection is considered mathematically by the control in inserted condition of the prism.

When the slanted prism depending on the direction of its affectivity causes a deflection in an X-direction this can be facilitated through respectively approaching another position through the card slide.

When this causes a deflection in Y-direction the movement of the impact point caused by the slanted prism has to be compensated through the control of the fan mirror.

There has thus been outlined, rather broadly, the more important features of a deflection mirror and device for laser inscribing in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

FIGS. 1a-1b illustrate a diagrammatic perspective view of a prism element.

FIGS. 2a-2d illustrate a diagrammatic perspective view of a prism support.

FIGS. 3a-3b illustrate a diagrammatic perspective view of a beam path.

FIGS. 4a-4d illustrate a diagrammatic perspective view of a laser inscribing device in various views and partial views.

FIGS. 5a-5c illustrate a diagrammatic perspective view of a deflection mirror unit installed in the base frame of the laser inscribing device.

### DETAILED DESCRIPTION OF THE PREFERRED EMBODIMENT

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

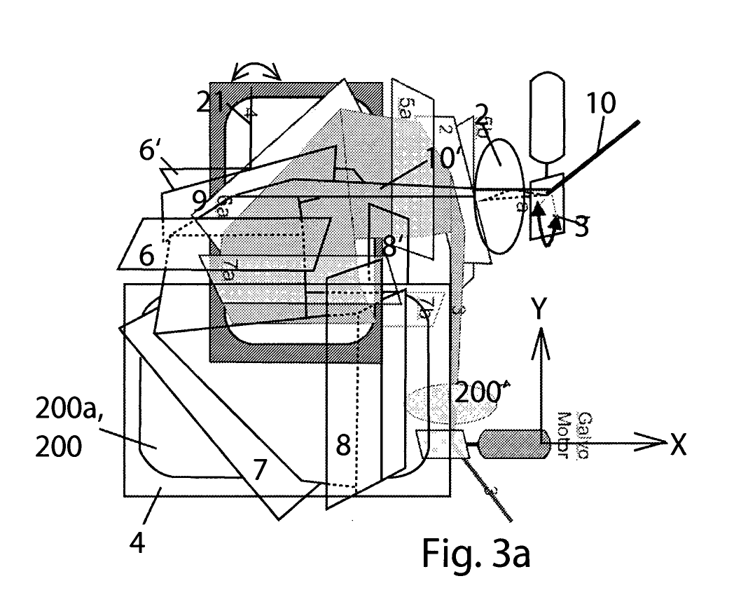

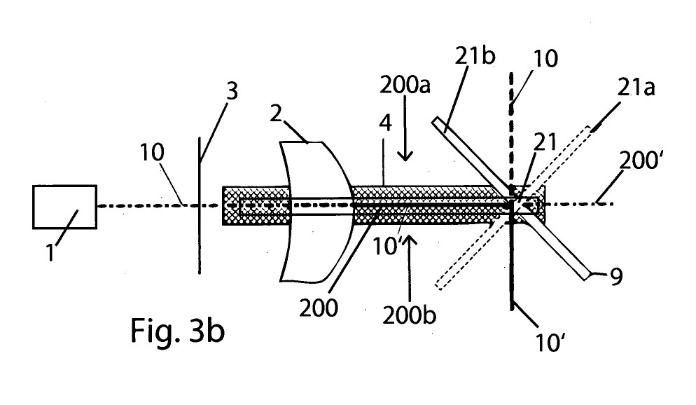

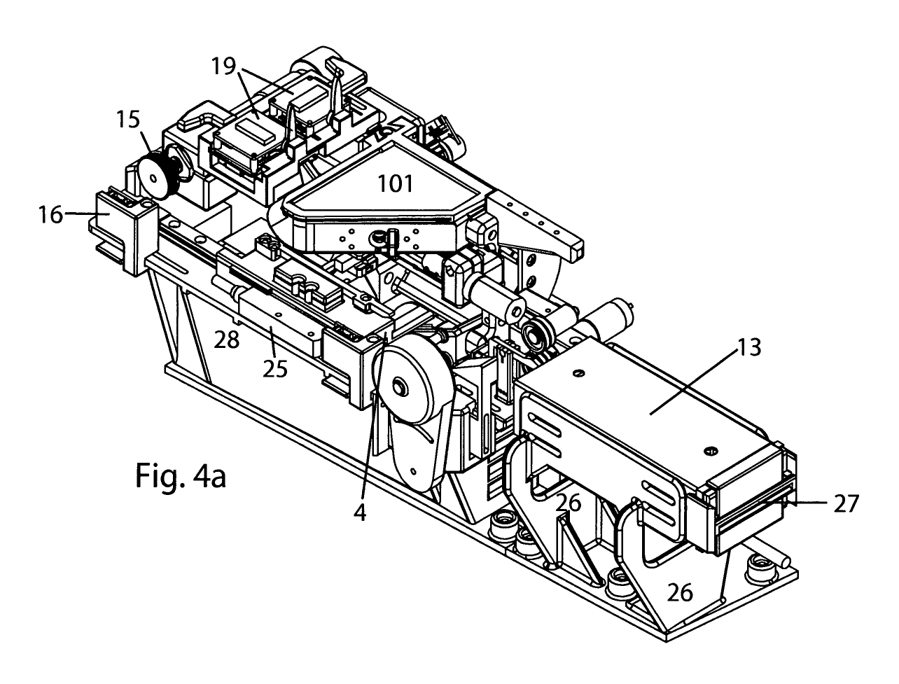

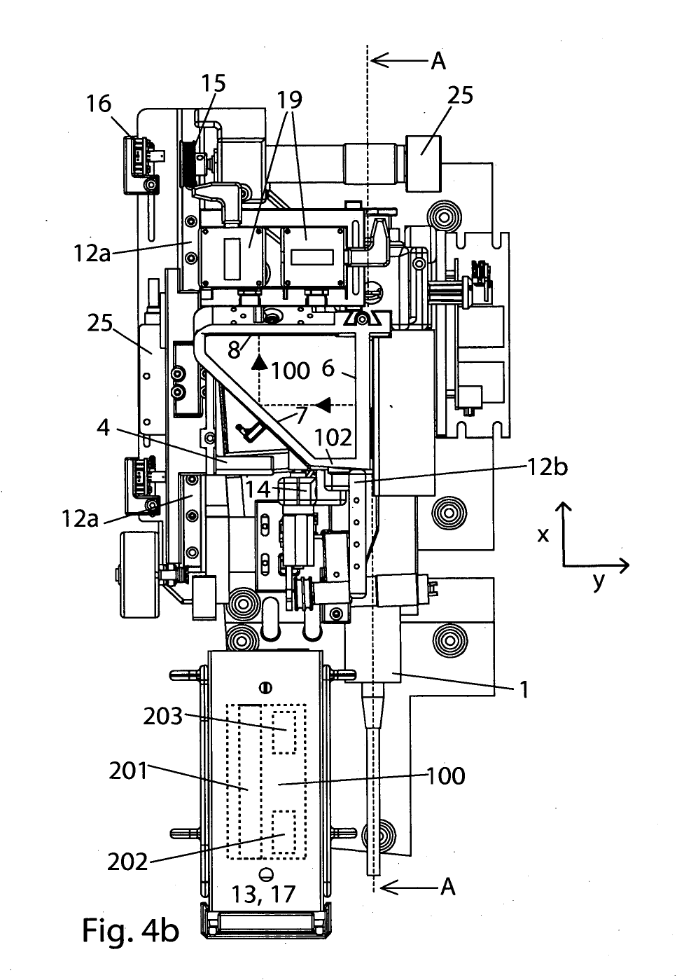

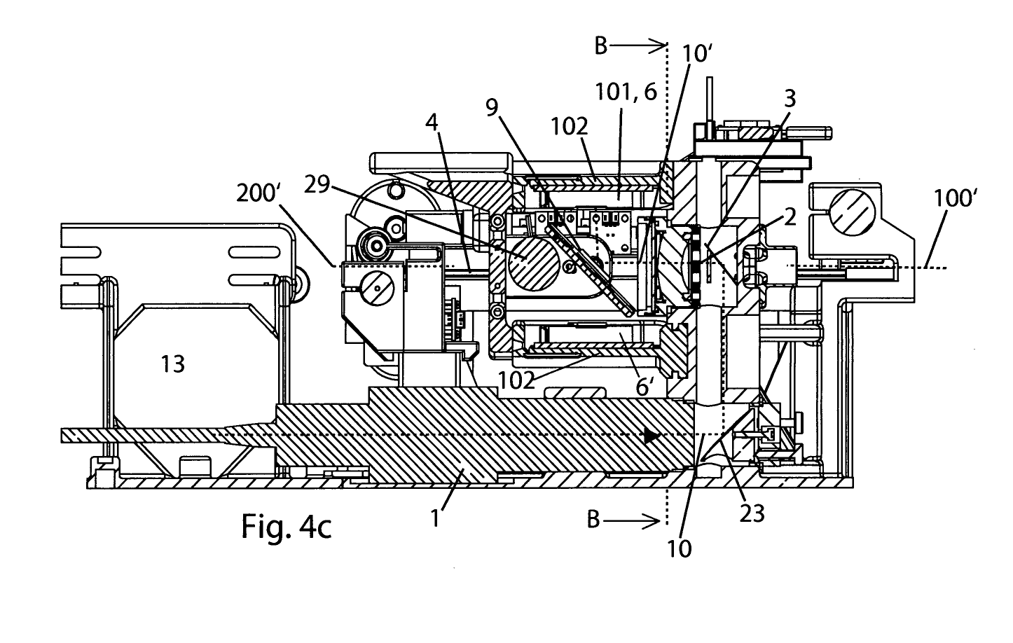

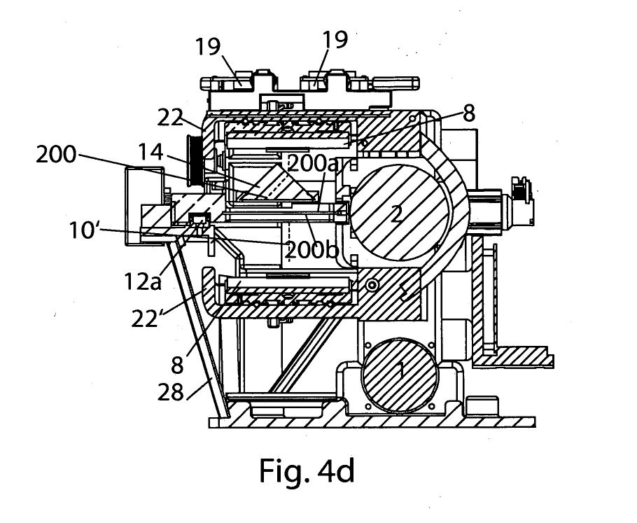

Initially the basic situation is illustrated in FIG. 3, wherein a card 200 is to be inscribed with the laser inscribing device according to FIG. 4, wherein the card lies flat in the laser inscribing device and is to be inscribed with the laser from a top and also from a bottom.

FIG. 3a illustrates the rectangular card 200 which is to be inscribed and which typically has circular corners and is received in a form locking manner in a card slide 4 which is movable in a controlled manner in X-direction, in this case the greater extension direction of the main plane 200′ of the card 200 and thus of the card slide 4.

A laser beam 10 is fanned at any location in the beam path to a beam fan 10′ wherein the fanning is initially performed adjacent to the card slide 4 through a fanning mirror 3 that pivots back and forth in an oscillating manner by a defined angular amount wherein the fanning mirror is respectively stopped in the intermediary portion incrementally at defined angular positions according to different Y-positions on the card 200 that need to be reached, wherein the beam fanning device yields a light-line extending in Y-direction or particular light points aligned one after another in Y-direction on a top side 200a of the card 200 when the laser is active at each Y-position.

Since no continuous line shall be generated on the card but only particular pixels shall be burnt in as a function e.g. of the writing to be generated, a control 5 controls the laser source 1 so that a pixel on the top side 200a of the card 200 is only burnt in by triggering a laser shot at the desired angular position of the fan mirror 3, thus the desired Y-position and naturally with the card slide 4 in the X-position predetermined for this purpose.

The beam fan 10′ is initially run through optics 2 which have the effect that the focal point of the respective laser beam is always on the surface 200a of the card 200 in the card slide 4, thus neither too high nor too low irrespective of the position of the movable mirrors arranged in the beam path.

The beam fan 10′ extending from the fan mirror 3 and after the optics 2 parallel to the movement direction of the card slide 4 adjacent to the card slide 4, wherein the plane of the beam fan 10′ is perpendicular to the main plane 200′ of the card 200 received in the card slide 4 is respectively deflected by 90° in the embodiment of FIG. 3a in sequence through four reflection surfaces 9, 6, 7, 8 that are arranged one after the other and permanently mounted so that the last deflection yields a line of light transversal to the movement direction, the X-direction of the card slide 4 over the entire width of the card 10 as an image of the beam fan 10′ on the card top side 200a.

The reflection surfaces 9, 6, 7, 8 thus respectively deflect the beam fan 10′ by 90° and have identical reflection properties in this respect and are thus produced identically, in particular they are configured with the same dielectric coating and are therefore particularly economical. The deflection mirrors 6, 7 are implemented as single prism element which is described later.

Since the deflection mirrors 9, 6, 7, 8 respectively have to deflect a beam fan 10′ the deflection mirrors have an elongated narrow configuration with a length according to the width of the beam fan 10′ at this location or slightly larger, however a much smaller width.

This way the entire surface of the card besides edge portions in which the card 200 is supported in the card slide 4 and which shall not be lettered anyhow can be inscribed at will with numbers, letters, logos, a picture of the car holder, symbols of the card provider etc. through incremental movement of the card slide 4 in X-direction respectively by the distance of a pixel.

The selection mirror 9 is in particular a mirror that is pivotable by 90° about a pivot axis 21 in parallel, in particular in the main plane 200′ of the card 200 arranged in the card slide 4 in this case in the drawing plane.

As illustrated in FIG. 3b the exterior mirror 9 is thus pivotable between two end positions 21a, 21b selectively conducting the beam fan 10′ into a portion above the main plane 200′ of the card 200 in the card slide 4 and thus to the deflection mirrors 6, 7, 8 according to FIG. 3a and from there to the top side 200a of the card 200 or in the other end position of the selection mirror 9 into the portion below the main plane 200′ and through fixated deflection mirrors 6′, 7′, 8′ analogously provided at this location to the bottom side 200b of the card 200.

FIG. 4c among other things illustrates the electric rotating magnet 29 which pulls the selection mirror 9 into one or another end position as a function of a loading with electric power.

Thus, the selection mirror does not pivot back and forth continuously but remains in its end position until the lettering of the top side 200a or of the bottom side 200b of the card 200 is completed.

FIG. 3b illustrates in a side view of the arrangement of FIG. 3a that the laser beam 10′ runs from the laser source 1 to the selection mirror 9 in one direction which does not only extend parallel to, but in the center main plane 200′ of the card 200 inserted into the card slide 4 wherein the main center plane is defined by the X- and Y-direction, thus the main extensions of the card 200 and is disposed in the center of the thickness of the card element 200.

This has the advantage that the selection mirror 9 in its end positions has to stand at a slant angle of plus or minus 45° relative to the direction of the laser beam 1 and thus has to go through a defined pivot angle of 90° with defined end positions which can be implemented relatively easily through a motor or electric rotating magnet that is controlled accordingly.

The beam fan 10′ is run through the second the last reflection surface 7 in a direction opposite to the original beam direction to the next mirror, which provides a particularly compact configuration for the device.

FIG. 4 illustrate an implemented device according to the invention in which the beam path differs in some non-essential details somewhat from the beam path in the block diagram in FIG. 3 as will be described infra in more detail.

Thus FIG. 4a is a perspective view from the top left while FIG. 4b illustrates an exact top view and FIG. 4c illustrates an exact side view from the right.

As apparent best from FIGS. 4b and 3a the elongated tube shaped laser source 1 is arranged in top view in the right lower portion of the device and extends over more than two thirds of its length.

Thus in order to keep the installed length of the device short the laser source 1 is arranged below the center main plane 200′ as apparent in FIG. 4c and deflected through two deflections by 90° respectively in a beam direction along the center main plane 200′, however still adjacent to the card slide 4 and behind the second of the two deflection mirrors 23, 3 in an opposite direction to the original beam direction directly behind the laser source 1.

Thus one of the two deflection mirrors, in this case the second of the two deflection mirrors can be arranged movable as a fan mirror 3 in order to split the laser beam 10 into the desired beam fan 10′.

The beam fan 10′ is initially conducted through focusing optics 2 and subsequently conducted to the selection mirror 9 that is pivotably arranged according to FIG. lb wherein the selection mirror 9 is in an end position in FIG. 4c so that the beam fan 10′ is deflected upward thus in a direction towards the top side 200a of the card slide 4 and impacts at this location the first deflection mirror that is visible in FIG. 4c of the three reflection surfaces 6, 7 and 8 wherein the reflection surfaces are formed at the prism element 101 which is arranged a second time in a mirror symmetrical arrangement, thus with analog reflection surfaces 6′, 7′, 8′ also below the main center plane 200′ as evident e.g. from FIG. 4c.

Differently from the schematic diagrams of FIGS. 3a and 3b thus the beam fan 10′ is not conducted through the second to last deflection mirror 7 or 7′ against the original radiation direction of the laser source 1, but parallel to its radiation direction which comes from the fact that in the implemented device the distance of the guide for the laser fan 10′ that is opposite to the original beam direction has already occurred in the portion between the fan mirror 3 and the selection mirror 9 in order to shorten the installed length.

From the last reflection surface 8 or 8′ of the prism element 101 the beam fan 10′ is radiated onto the card surface 200a, b in a perpendicular manner.

Thus, an additional slanted prism 14 is inserted above the card 200 in FIG. 4d into the beam path between the last deflection mirror 8 and the top side 200a of the card 200 wherein the slanted prism deflects the beam fan 200′ to a side viewed in a longitudinal direction of the device and thus in a movement direction of the card slide 4 so that the beam fan does not impact the top side 200a of the card 200 at a right angle, but at a slant angle. An analog slanted prism 14 can also be provided on the bottom side.

Thus, a card surface includes an optical structure that is suitable for CLI or MLI a laser inscription on the card 200 is implemented in that different images are viewed by a viewer depending on the viewing angle of the surface of the card 200 or an image burned in by a laser 1 is only visible from a particular viewing angle and not visible from other viewing angles.

In FIG. 4b, however, the prism is in a deactivated pulled back position from which it can be moved forward according to FIG. 4b thus automatically moved forward under the last reaction surface 8. Furthermore two CCD-chips 19 are arranged in FIG. 4b above the main center plane 200′ and behind the mirror holder 22 with a downward viewing direction onto the main center plane 220′ in order to initially measure after inserting the card 200 into the card slide 4, where the pre-print 202 is already disposed on the card 200 in particular with respect to the arrangement of the pre-print relative to the device.

For this purpose the movement path of the card slide 4 is configured sufficiently long in order to let the card slide 4 move initially under the CCD-chips 19 before beginning the inscribing through the laser wherein the CCD-chips initially detect the placement of the pre-print 202 on the card 200 and change the positioning of the laser inscription on the card 200 when the actual position of the pre-print deviates too much from the target position or also designate the card blank as scrap and do not inscribe it.

For this purpose the two CCD-chips 19 are respectively arranged strip-shaped in X-direction and in Y-direction in order to be able to detect the side edges of a pre-print extending in these directions.

As furthermore illustrated in the figures an electronic inscribing unit 13 is arranged in front of the actual laser inscribing unit wherein the electronic inscribing unit is typically mounted as a purchased component in front of the actual laser inscribing unit in a position of this type in this case on the transversally arranged support plates 26 so that the card 200 inserted into the insertion slot 27 at a front end of this unit 13 which is transported further through independent transport devices in the interior of this unit and inserted at the rear end through an analog outlet, is in alignment with the subsequent movement path of the card slide 4 and extends horizontally like the card slide 4.

Also the transfer of the card 200 from this unit 13 into the card slide 4 and back is performed automatically in that the card slide 4 during transfer in its start position is directly behind the inscribing unit 13 and a card pushed out by this inscribing unit is directly pulled into the frame shaped card slide 4 through an electrically driven roller, wherein the card contacts the card slide with its edges on the outside circumferentially in a narrow portion. As soon as the card slide moves out of its starting position the card is supported above through a spring arm of the card slide 4 which is disposed at the end of the card slide 4 that is arranged opposite to the inscribing unit 13 and under which the card 200 is automatically pushed by the unit 13.

The card 200 inscribed through the laser is transported back in the same way after completing the inscribing process thus in that the card slide 4 moves back to the starting position and the card 200 is automatically pushed out of the card slide 4 in this position and inserted into the outlet slot of the unit of the electronic inscribing unit 13.

At this location the card 200 is being engaged and ejected from the insertion slot 27 at the front end of the unit 13 as a completely inscribed card 200.

Inscribing the magnetic strip 201 and/or the electronic chip 103 of the card can thus be performed optionally on the forward path of the card 200 or on the backward path of the card through the electronic inscribing unit 13.

In the rear end portion furthermore the suction device is visible which suctions air from the inscribing location and conducts it through an active charcoal filter 16 from the housing of the device which is not illustrated in the figures.

The side wall 28 that is visible in the FIG. 4d is a portion of the base frame 17 at which all components of the unit are attached. The base frame is primarily used for stabilizing the inner content and for air-ducting during suctioning from the inscribing location.

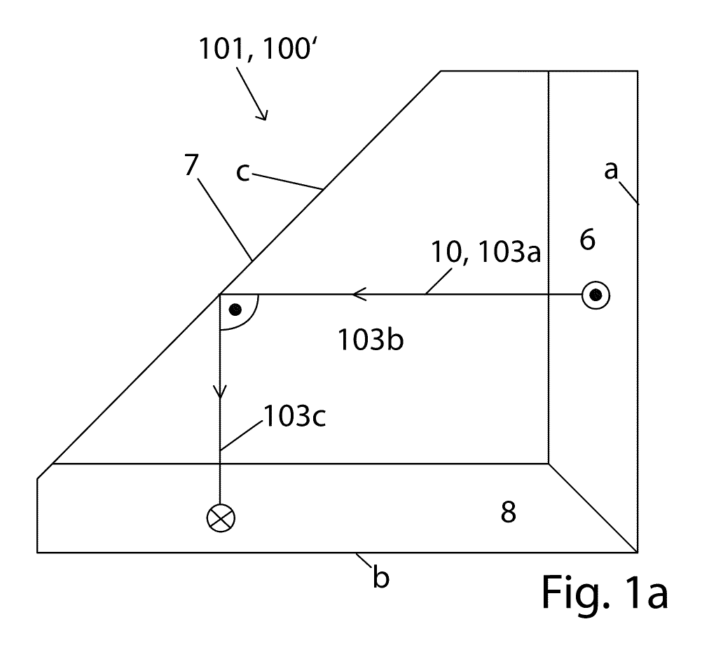

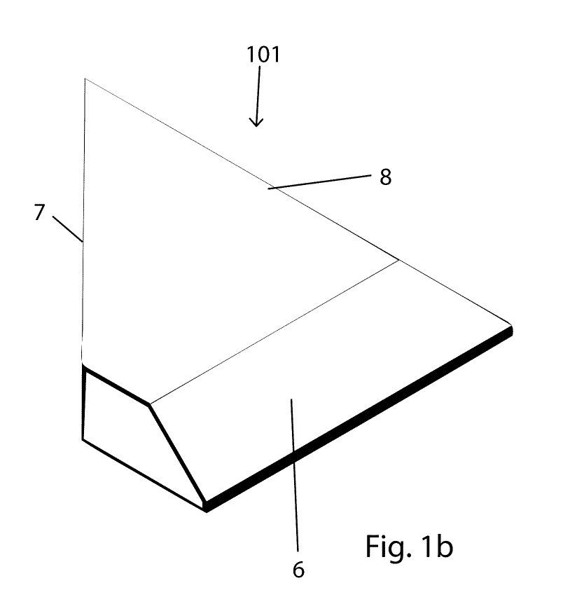

FIG. 1 illustrate the prism element 101 that is essential for the invention at which the three reflection surfaces 6, 7, 8 are configured in a view from above and in a perspective view and at which the laser beam 10 is respectively reflected in its entirety.

In the top view of FIG. 1a the plate shaped prism element 101 is a rectangular triangle in which both corners between the hypotenuse c and the catheti a, b are cut off but are cut off by a different amount so that it is actually a pentagonal shape in top view.

Along the catheti a, b the narrow side of the plate shaped base element of the prism element 101 is beveled and thus respectively forms the reflection surfaces 6, 8 while the additional reflection surface 7 disposed there between is formed by the non-beveled narrow side of the hypotenuse c.

The reflection surfaces 6, 7, 8 respectively have the same reflection conditions and a beam deflection by 90° is in particular performed at each reflection surface.

According to FIG. 1a the beam impacts the drawing plane vertically from below and is deflected by 90° into the drawing plane. This defines a first deflection plane 103a.

At the reflection surface 7 the beam is deflected within the drawing plane by 90° which defines a second deflection plane 103b, namely parallel to the main plane 100′ of the prism element 101 through the incoming and the outgoing beam at this reflection surface 7.

The beam is deflected from the main plane in downward direction perpendicular to the drawing plane at the reflection surface 8 which defines a third deflection plane 103c through an incoming and exiting beam at the reflection surface 8.

This illustrates furthermore that the three deflection planes 103a, b, c stand on one another in a perpendicular manner and the pivot angle there between is respectively 90° and the pivot direction is a continuous pivot direction.

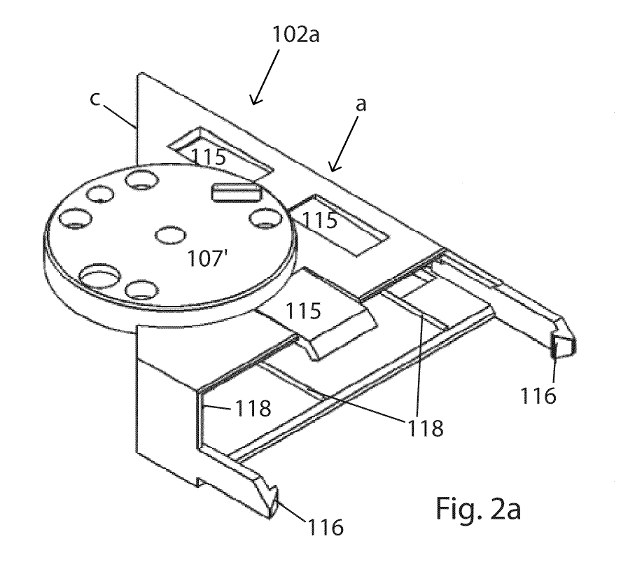

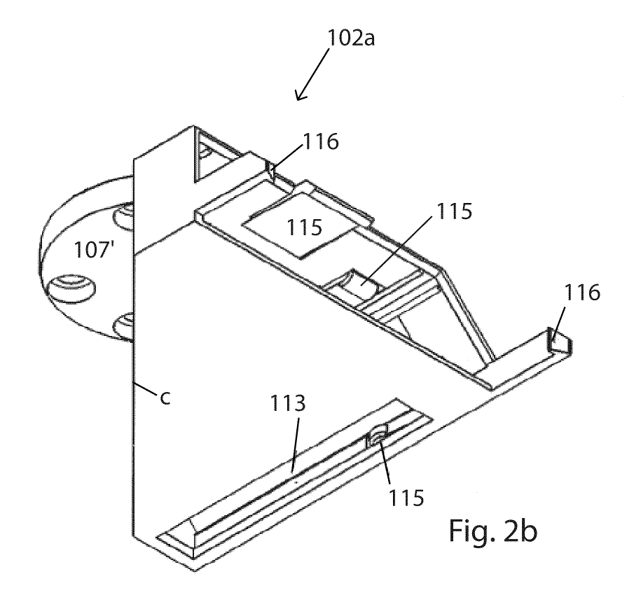

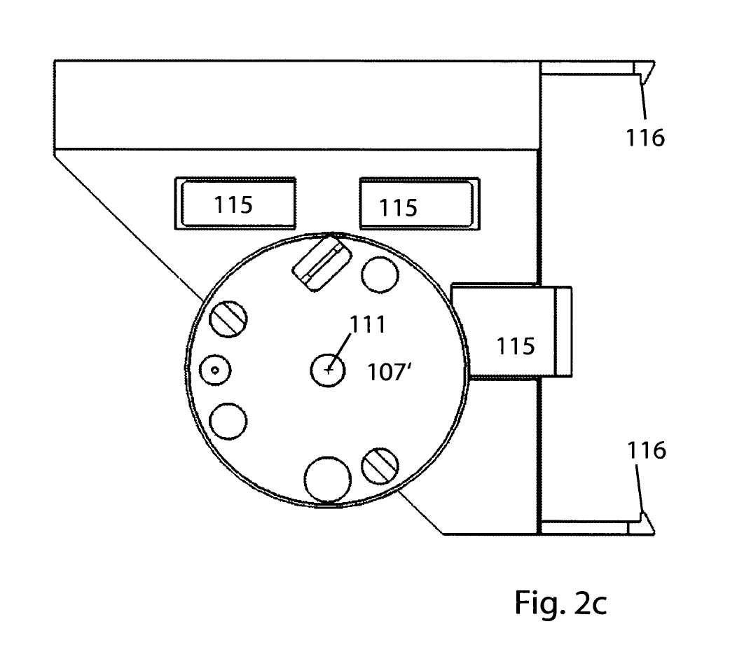

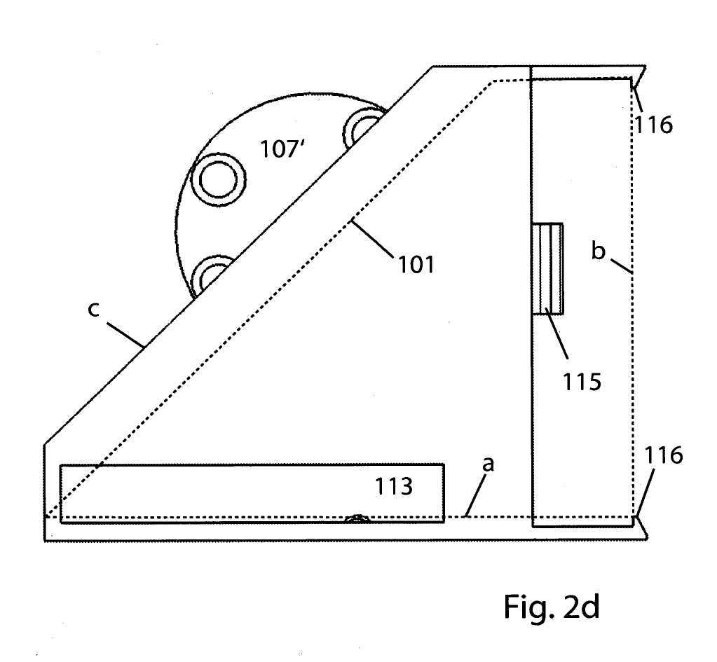

In order to be able to handle the prism element 101 better and in particular in order to be able to perform the necessary alignment of the prism element 101 in the laser inscribing device, thus in particular the prism element 101 is fixated in the prism component 102a of a prism support 102 which is illustrated in FIG. 2 and thus only the prism support 102 is handled and aligned.

The base component 102a of the prism support 102 is a plastic component which is illustrated in FIGS. 2a and 2b in a perspective view from below and in FIGS. 2c and 2d in the exact view from above and below.

Thus the basic triangular shape according to the prism element 101 is visible at the prism component 102a in the top views. The prism component 102a is made from a top plate and a bottom plate which include transversal walls along a cathetus a of the triangular shape and in the portion of the cut off corner so that a circumferential frame is created in that the prism element 101 is arranged as only indicated in FIG. 2d:

Thus the prism element 101 with its other cathetus b protrudes from the circumferential frame to the support lock 118 which protrude from there from the extended side walls inward.

The prism element 101 is inserted from the open cathetus b, wherein the support lugs 116 are initially bent apart and then snap lock behind the prism element which contacts the closed side c of the prism component 102.

Furthermore plural spring tongues 115 are configured in the top side of the prism component 102a wherein the spring tongues press downward onto the inserted prism element 101 and support the prism element 101 and press it in contact with the stops 118 without any clearance at the bottom side and the transversal wall of the prism component 102.

Furthermore along the cathetus a, a pass through opening 113 is illustrated in the bottom side of the prism component 102a for beam entry into the prism element 101. The exit does not require a separate pass through opening since it is the freely protruding portion of the prism element 101 that reaches to the support lugs 116.

A spring tongue 115 is also configured in the side wall of the cathetus a, wherein the spring tongue presses the prism element 101 against the opposite side wall.

A circular disc 107′ is integrally configured together with the top plate of the prism support 102 wherein the circular disc protrudes with respect to its elevation over the top side of the prism component 102a and also approximately with half of its diameter beyond the slanted rear edge, thus the hypotenuse c of the prism component 102a.

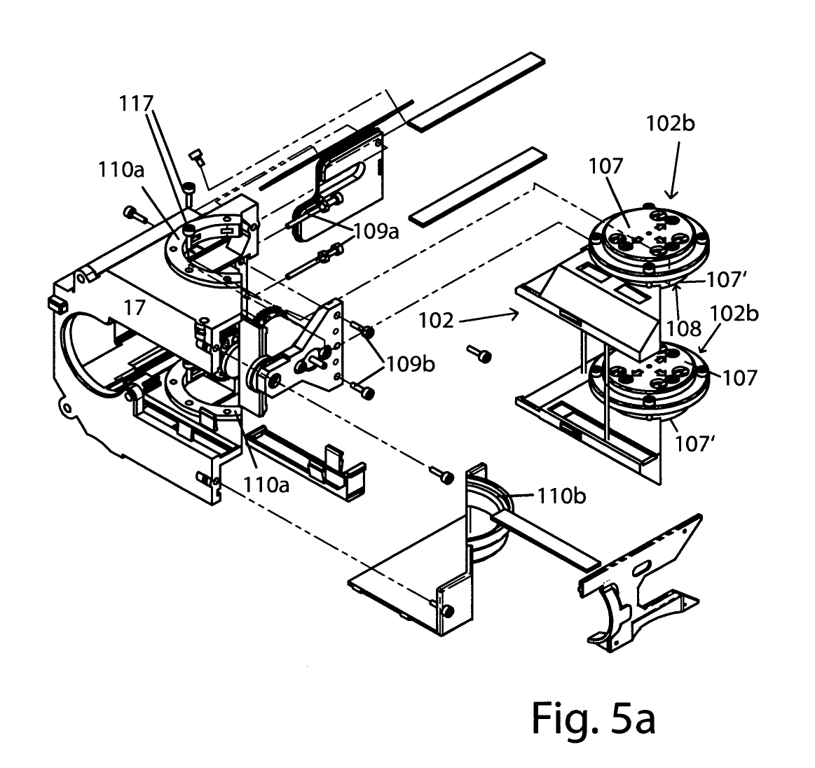

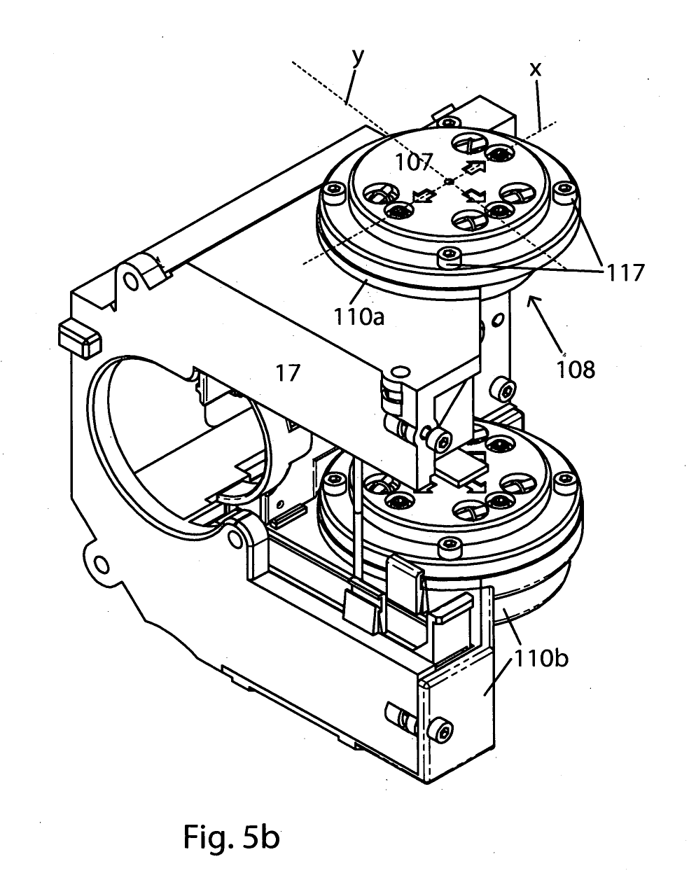

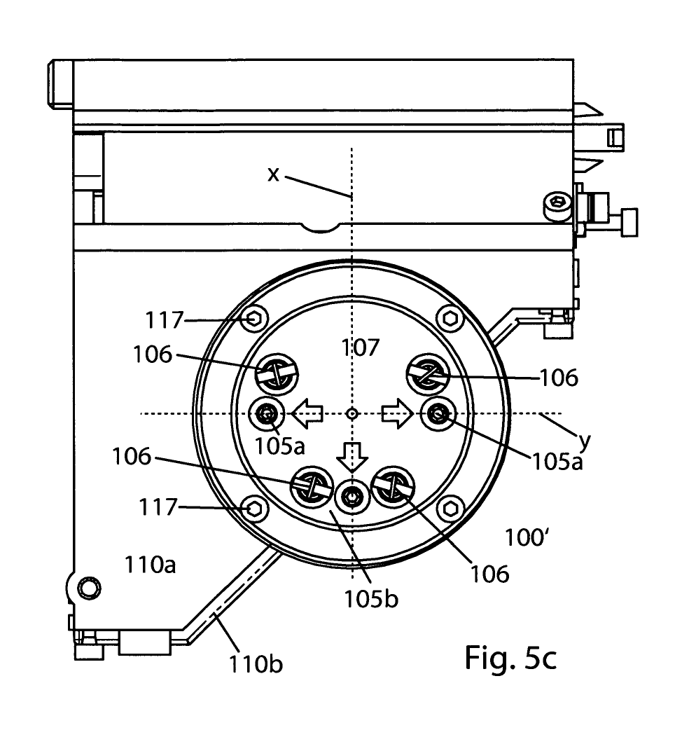

The prism component 102a with the prism element 101 inserted therein without clearance, e.g. supported through form locking is then completed to form a deflection mirror unit 100 and possibly installed in the base frame 17 of the laser inscribing device as illustrated in FIG. 5.

For this purpose initially the one-piece prism component 102a described in FIG. 2 is completed to form a prism support 102 in that a second disc 107 is mounted over the disc 107′ in this location wherein the second disc 107 is pivotable through pivot screws 105a, b relative to the disc 107′ disposed there under in order to define one of the two directions, thus e.g. the X-direction or the Y-direction which define the main plane 100′ of the deflection mirror unit and thus also of the disc 107.

The pivot screws 105a, b thus extend perpendicular to the main plane 100′ between the discs 107, 107′ tension springs 106 are arranged and thus respectively out of center so that the discs pull against one another.

The distance how far the discs 107, 107′ pull against one another is a function of how far the pivot screws 105a, b are screwed in relative to the upper disc 107 and thus how far they protrude from the upper disc 107 in downward direction toward the lower disc 107′ relative to which they are supported with its forward face.

As illustrated in particular in FIG. 5c one respective pivot screw 105a is arranged with respect to the X-axis on two opposite sides so that a pivoting of the prism element about the X-axis can be performed by threading in one of the two pivot screws.

Thus, the exact position of the X-axis is not predetermined, but is in a portion between the two pivot screws 105a.

For pivoting about the Y-axis even only one pivot screw 105b is arranged on only one side of the Y-axis which is not defined exactly either but which is sufficient for this purpose.

However, when all pivot screws 105a, b are screwed in the same direction the distance between the discs 107, 107′ is increased or reduced and thus the elevation position of the focal point of the laser beam is adjusted with respect to the card surface in C-direction.

This disc 107 is the fixation component 102b of the prism support 102 and includes a circumferential, in this case annular face of the shoulder 108 through which it can be received in an annular housing 110. The housing 110 in this case is a component of the base frame 17 of the entire machine and furthermore in particular a ring that is not integrally closed but a housing made from two segments namely the housing components 110a, b.

The fixation component 102b is inserted into a first housing component 110a and fixated through the second housing component 110b.

FIG. 5a illustrates the two deflection mirror units 100 wherein one of them is arranged above the center main plane 200′ and another one is arranged below the center main plane 200′ thus of the card plane and FIG. 5 also illustrates the relevant components of the base frame 17 of the machine in an exploded view.

Therein it is apparent that the fixation component 102b is bolted to the housing 110a, b after insertion through the vertical screws in the outer ring portion.

Thus, a rotation of the prism support 102 and thus of the prism element 101 about the rotation axis of the annular housing 110 is possible by a small extent in that the tension bolts 109a, b tangentially arranged in the housing 110 are threaded forward and press in circumferential direction against the prism support 102 or the fixation component 102a of the prism support slightly rotating the prism support.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

### REFERENCE NUMERALS AND DESIGNATIONS

1 laser source
2 optics
3 fan mirror
4 card slide
6, 6′ reflection surface
7, 7′ reflection surface
8, 8′ reflection surface
9 selection mirror
10 beam path, laser beam
10′ beam fan
12a, b support
13 electronic inscribing unit
14 slanted prism
15 suction device
16 charcoal filter
17 base frame
19 CCD chip
21 pivot axis
27 insertion slot
28 side wall
29 magnet
100 deflection mirror unit
100′ main plane
101 prism element
102 prism support
102a prism component
102b fixation component
103a, b, c deflection plane
104a, b pivot angle
105a, b pivot screw
106 spring
107, 107′ disc
108 shoulder
109a, b pivot screw
110 housing
110a, b housing component
111 center
113 pass through opening
116 support lug
117 attachment screw
118 stop
a, b cathetus
c hypotenuse
200 card
200a top side
200b bottom side
200′ main plane, center main plane
201 magnetic strip
202 preprint
203 chip

What is claimed is:

1. A deflection mirror unit for three optical beam deflections of a laser beam, comprising:
a single prism element with three reflection surfaces which provide total reflection, wherein the main plane of the prism element extends through all three reflection surfaces;
a prism support for receiving a prism element; and
a housing for receiving the prism support,
wherein, the deflection planes defined by an incoming and an outgoing beam for each deflection of the three deflections to the respective adjacent deflection plane, are arranged at a pivot angle, in particular of ninety degrees respectively relative to one another, wherein,
pivot elements, in particular pivot screws are provided for pivoting the prism support about the two defining directions, in particular the X-direction and the Y-direction of the main plane of the prism element relative to the housing.

2. The deflection mirror unit according to claim 1, wherein the prism support is made from two components that are moveable relative to one another, the prism component receiving the prism element and the fixation component fixated at the housing, in particular directly fixated and the pivot elements are arranged there between so that they can pivot both components relative to one another.

3. The deflection mirror unit according to claim 1, wherein springs, in particular tension springs are arranged between the prism component and the fixation component, wherein the tension springs hold the two components at a preload relative to one another.

4. The deflection mirror unit according to claim 1, wherein the pivot elements, in particular the pivot screws extend transversal to the main plane of the prism element and at least one pivot element, in particular a pivot screw is arranged offset from the pivot axis or two pivot elements are arranged on opposite sides of the pivot axis for pivoting about one direction, thus the X-direction and/or wherein the fixation component and the prism component of the prism support can be varied with respect to a distance from one another for adjusting the height of the focal point of the laser beam in a direction perpendicular to the main plane of the prism element through adjusting all pivot elements, in particular the pivot screws, in the same direction.

5. The deflection mirror unit according to claim 2, wherein the fixation component is a disc or a ring with a circular outer circumference and the receiving housing contacts the outer circumference at least through circumferential elements and/or wherein the circular fixation component includes a radial surface, in particular a circumferential shoulder through which it contacts the housing and/or rotation elements, in particular rotation screws are provided between the circular fixation component and the housing, wherein the rotation screws can rotate the fixation component relative to the housing, and/or the adjustment elements and/or, wherein the adjustment elements and/or the rotation elements are configured self hemming.

6. The deflection mirror unit according to claim 1, wherein the housing is configured in two components and contacts the circular fixation component with each of its housing components in particular over one hundred eighty degrees of the circumference at the most and the two housing components are in particular bolted together, and/or the circular fixation component is arranged offset parallel to the main plane of the prism element above the prism element, and/or the prism element forms a triangle with a right angle whose hypotenuse (c) is arranged at an angle of forty-five degrees respectively to the two catheti and in which in particular at least one corner is cut off.

7. The deflection mirror unit according to claim 6, wherein the hypotenuse (c) extends under the circular fixation component and in particular under its center and/or, the fixation component is bolted to the housing through fixation bolts which extend through the fixation component through pass through openings that are larger than the fixation screws.

8. The deflection mirror unit according to claim 1, wherein the prism support includes at least one pass through opening in the portion of the entering or exiting laser beam and an insertion opening arranged transversal to the main plane is in particular one cathetus of the triangle, and/or a transparent cover is provided in the prism support or in the housing, wherein the cover covers the pass through opening and prevents a contamination of the surface of the prism element in this portion and the cover is replaceable in particular, and/or the prism support and/or the housing are made from plastic material.

9. The deflection mirror unit according to claim 1, wherein the prism element is received in the prism support without clearance, and/or wherein the prism element is received in the prism support through form locking, in particular exclusively through form locking.

10. The deflection mirror unit according to claim 1, wherein the prism support includes at least one control opening remote from the pass through openings, wherein the path of the laser beam is visible through the pass through opening and adjustment markings are provided at an edge of the control opening at the prism support, and/or wherein the prism support includes at least one spring tongue which presses the prism element against a defined stop of the prism support, in particular transversal to the main plane.

11. A laser inscribing device for both sides of a card whose main plane extends in an X-direction and a Y-direction comprising:
a base frame;
a laser source;
optics focusing the laser source;
a fan mirror in a beam path of a laser beam, wherein the fan mirror pivots back and forth in an oscillating manner in Y-direction, in particular only in Y-direction;
the laser source emits the laser beam in a parallel direction, in particular on the center main plane of the card slide;
three fixated reflection surfaces for the laser beam are arranged in the beam path of the laser on the same side of the center main plane;
the three fixated reflection surfaces are implemented through a deflection mirror unit according to claim 1; and
wherein the housing of the deflection mirror unit is in particular an integral component of the base frame.

12. The laser inscribing device according to claim 11, wherein only one of the housing components is an integral component of the base frame and/or wherein a respective deflection mirror unit is provided on each side of the card main plane and in particular symmetrical there to.

13. The laser inscribing device according to claim 11, wherein the laser beam oscillating in Y-direction on the card surface is always directed to the same X-position of the device, wherein a card side is moveable in a controlled manner parallel to the X-direction, wherein a control of the device controls the X-movement of the card slide and triggers a laser impact as a function of the angular position of the fan mirror and the X-position of the card slide.

14. The laser inscribing device according to claim 13, wherein the card slide only includes edge receivers for the card, wherein a selection mirror that is pivotable back and forth between two positions for the top side and the bottom side of the card is arranged in front of the fixated reflection surfaces in the beam path of the laser so that the laser beam is optionally directed to one or another side with respect to the main plane of the card slide and the reflection surfaces arranged at this location.

15. The laser inscribing device according to claim 14, wherein the selection mirror is pivotable by ninety degrees between the two positions and in particular the selection mirror is arranged about a pivot axis extending in Y-direction adjacent to the card slide and/or the optics for the laser beam are arranged in the beam path after the fan mirror and in front of the selection mirror.

16. The laser inscribing device according to claim 11, wherein the three reflection surfaces have the same reflection conditions, in particular respectively one beam deflection by ninety degrees and/or wherein the device, in particular on each side of the main plane of the card slide includes a slanted prism for slanted impact of the laser beam on the card surface, or a slanted mirror which are moveably arranged so that they can be moved into the beam path of the laser beam and out of the beam path of the laser beam and/or wherein the slanted prism can be positioned in the beam path between that last fixated deflection mirror and the card slide.
